(19) United States
(12) Patent Application Publication
(10) Pub. No.: US 2012/0202636 A1
(43) Pub. Date: Aug. 9, 2012

(54) Halfshaft-Differential Disconnect Mechanism

(75) Inventors: Andreas E. Perakes, Canton, MI (US); Laurence A. Deutsch, Farmington Hills, MI (US); Timothy T. Ugabawua, 13826 Marina Drive, MI (US)

(73) Assignee: FORD GLOBAL TECHNOLOGIES, LLC, Dearborn, MI (US)

(21) Appl. No.: 13/022,672

(22) Filed: Feb. 8, 2011

(51) Int. Cl. B60K 23/08; B60K 17/346; F16H 48/06

(52) U.S. Cl. 475/220; 475/31

(57) ABSTRACT

An assembly selectively disconnecting a road wheel from a power source, includes a differential mechanism transmitting rotating power between the power source and an output shaft, a halfshaft, and a disconnect mechanism releasably secured mechanically to the differential mechanism and alternately opening and closing a drive connection between the output shaft and the halfshaft.

### BACKGROUND OF THE INVENTION

1. Field of the Invention

This invention relates generally to a motor vehicle driveline, particularly to disconnecting a half shaft or axle shaft from a differential mechanism.

2. Description of the Prior Art

Driveline disconnect devices have long been used on rear-wheel drive (RWD) based four wheel drive (4WD) vehicles to provide significant improvement in fuel economy while operating in two wheel drive (2WD) mode. In a RWD-based 4WD vehicle, the transfer case provides a natural location to disconnect torque input to the secondary axle, i.e. the front axle, of a RWD-based 4WD vehicle driveline.

To maximize fuel economy, vehicle manufacturers have used wheel end disconnect devices, such as hub locks and integrated wheel end disconnects, which effectively eliminate spin losses from the entire secondary driveline. Alternate means, such as center axle disconnects, decouple one halfshaft from the differential, leaving the other halfshaft to back-drive the side gears. These alternate means are far simpler to execute, but only produce about one-half to two-thirds the fuel economy improvement potential attainable with wheel end disconnects.

To maximize fuel economy, it is desirable to disconnect both halfshafts from the differential mechanism. Unfortunately, integrated wheel end disconnects (IWEs) require a purposed-designed wheel end to accommodate them. Wheel ends not designed for IWEs and center axle disconnect devices require a large retooling investment to retrofit them later.

### SUMMARY OF THE INVENTION

An assembly selectively disconnecting a road wheel from a power source, includes a differential mechanism transmitting rotating power between the power source and an output shaft, a halfshaft, and a disconnect mechanism releasably secured mechanically to the differential mechanism and alternately opening and closing a drive connection between the output shaft and the halfshaft.

The modular nature of the mechanism permits it to be connected mechanically to existing structure, thereby significantly improving investment efficiency.

The dual disconnect mechanism provides significantly better vehicle fuel economy compared to conventional axle disconnects.

The mechanism avoids the large investment expense associated with retooling wheel ends for IWEs by moving the disconnect devices inboard such that they mount on the axle.

The mechanism enables a running change wherein the same axle can be used with or without the disconnect function, providing a significant improvement in investment efficiency compared to purpose-built designs.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a cross sectional top view taken at a diametric plane through the drive unit of a motor vehicle.

### DESCRIPTION OF THE PREFERRED EMBODIMENT

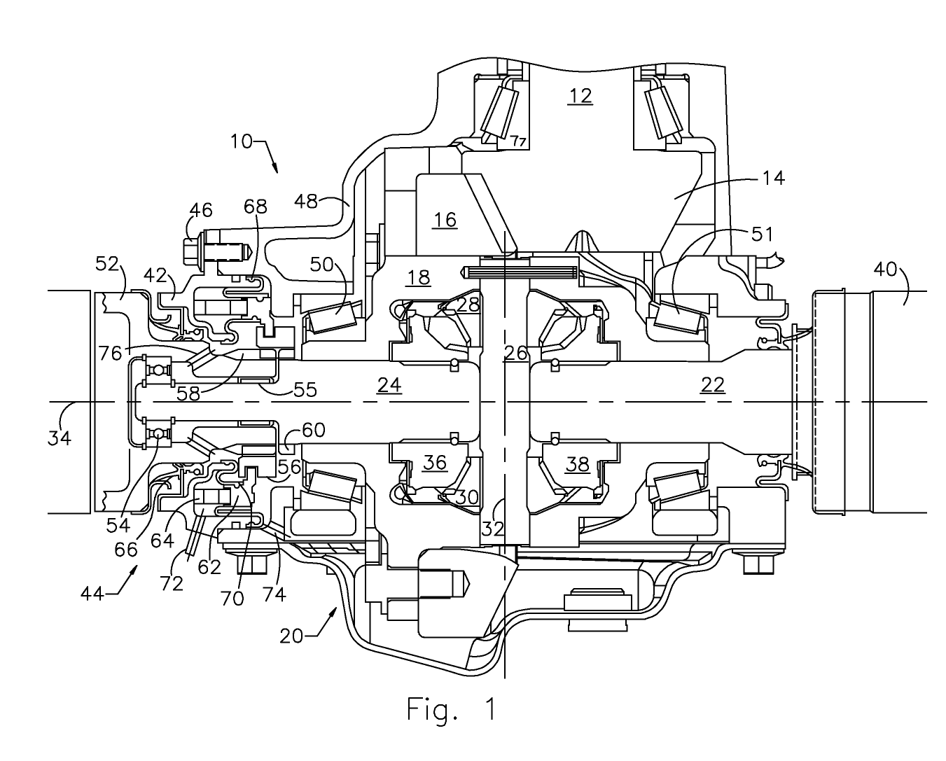

FIG. 1 illustrates the drive unit 10 for the secondary wheels of a motor vehicle. A driveshaft 12 transmits rotating power from a power source, such as an engine or electric motor, through a bevel pinion 14, and a bevel gear 16, which meshes with the pinion and is secured to the carrier 18 of an interwheel differential mechanism 20. The secondary wheels of the vehicle are driven by the differential 20 through output shafts 22, 24.

The differential 20 includes a pinion shaft 26, secured to the carrier 18 for rotation with the carrier; bevel pinions 28, 30 supported on shaft 26 for rotation about axis 32 and revolution about axis 34; side bevel gears 36, 38, meshing with pinions 28, 30 and secured to output shafts 24, 22, respectively. Output shaft 22 is connected by a right-hand halfshaft 40 and to the right-hand secondary road wheel. Output shafts 24, 22 are supported on bearings 50, 51, respectively.

A casing 42, which encloses a disconnect mechanism 44, is secured at a bolt circle by a series of bolts 46 to a housing 48, on which bevel pinion 14 is supported by a bearing 77. A modified halfshaft assembly 52 is supported on left-hand output shaft 24, which is driveably connected to the left-hand road wheel. Bearings 54, 55 support halfshaft assembly 52 on output shaft 24.

The disconnect mechanism 44 includes a locking collar 56, which is continually secured by meshing axial spline teeth 58 formed on halfshaft assembly 52 and is selectively secured by meshing axial spline teeth 60 formed on output shaft 24. Locking collar 56 is secured to an actuator piston 62, which is biased by a compression spring 64 that continually urges the locking collar toward the connected position shown in the FIGURE above the axis 34.

A rotary seal 66, located between surfaces of the modified halfshaft assembly 52 and the casing 42 of the disconnect mechanism 44, seals the volume within casing. An outer diaphragm seal 68 is located between and is secured to surfaces of the housing 48 and actuator piston 62. An inner diaphragm seal 70 is located between and is secured to surfaces of the actuator piston 62 and the casing 42 of the disconnect mechanism 44.

A vacuum passage 72 is connected to a vacuum source or a source of low pressure. A lube passage 74 carries lubricant to a sump in the lower elevation of the differential housing 48. Internal passages 76 carry lubricant to the bearings 54, 55.

In operation, when differential pressure is applied across piston 62, a pressure force due to the differential pressure acting on the piston in opposition to the force of spring 64 causes locking collar 56 to slide on the spline teeth 58 of halfshaft 52 leftward along axis 34 to the disconnect position shown below axis 34, thereby disengaging the locking collar from the spline teeth 60 of output shaft 24 and disconnecting output shaft 24 from the left-hand halfshaft 52 and the left-hand road wheel.

When differential pressure across piston 62 is removed, spring 64 forces piston 62 rightward causing locking collar 56 to slide on the spline teeth 58 of halfshaft 52 rightward along axis 34 to the connect position shown above axis 34, thereby reengaging the locking collar with the spline teeth 60 of output shaft 24 and reconnecting output shaft 24 with the left-hand halfshaft 52 and the left-hand road wheel.

Although the disconnect mechanism 44 is described as being actuated by vacuum pressure, the disconnect mechanism may be actuated pneumatically or hydraulically, either by a positive pressure applied to the inboard side of piston 62, or by a negative pressure applied to the outboard side of piston 62. Similarly, electro-mechanical energy can also be used to act directly upon locking collar 56.

Another drive unit 10 may be installed at the right-hand side of the differential 20 substantially as described with respect to the left-hand side, such that rotating inertial and frictional drag associated with the driveline components that transmit power to the right-side wheel is eliminated when the right-hand drive unit is disconnected from differential output shaft 22.

In accordance with the provisions of the patent statutes, the preferred embodiment has been described. However, it should be noted that the alternate embodiments can be practiced otherwise than as specifically illustrated and described.

The invention claimed is:

1. An assembly selectively disconnecting a road wheel from a power source, comprising:
a differential mechanism transmitting rotating power between the power source and an output shaft;
a halfshaft;
a disconnect mechanism releasably secured to the differential mechanism and alternately opening and closing a drive connection between the output shaft and the halfshaft.

2. The assembly of claim 1, wherein the halfshaft transmits power to a road wheel that is a member of a set of secondary road wheels.

3. The assembly of claim 1, wherein the halfshaft transmits power to one of a set of rear road wheels.

4. The assembly of claim 1, wherein the disconnect mechanism further comprises:
a locking collar continually secured to the halfshaft and displaceable into releasable engagement with the output shaft.

5. The assembly of claim 1, wherein the disconnect mechanism further comprises:
a locking collar continually secured to the halfshaft and displaceable into releasable engagement with the output shaft;
a sealed chamber containing a displaceable piston connected to the locking collar; and
a source of actuating pressure communicating with the chamber and producing differential pressure across the piston.

6. The assembly of claim 1, wherein the disconnect mechanism further comprises:
a locking collar continually secured to the halfshaft and displaceable into releasable engagement with the output shaft;
a sealed chamber containing a displaceable piston connected to the locking collar;
a source of actuating pressure communicating with the chamber and producing differential pressure across the piston; and
a spring urging the locking collar to engage the output shaft.

7. The assembly of claim 1, wherein the disconnect mechanism further comprises:
a locking collar continually secured to the halfshaft and displaceable into releasable engagement with the output shaft.
a sealed chamber containing a displaceable piston connected to the locking collar; and
a source of actuating pressure communicating with the chamber and producing differential pressure across the piston.

8. The assembly of claim 1, wherein the source of actuating pressure is one of a source of pneumatic pressure and a source of hydraulic pressure.

9. The assembly of claim 1, wherein the source of actuating pressure is one of a source of positive pressure and a source of negative pressure.

10. An assembly for disconnecting road wheels, comprising;
a differential mechanism transmitting rotating power between the power source and first and second output shafts;
a first mechanism releasably secured to the differential mechanism, alternately opening and closing a drive connection between the first output shaft and a first halfshaft;
a second mechanism releasably secured to the differential mechanism, alternately opening and closing a drive connection between the second output shaft and a second halfshaft.

11. The assembly of claim 10, wherein each halfshaft transmits power to a road wheel that is a member of a set of secondary road wheels.

12. The assembly of claim 10, wherein each halfshaft transmits power to one of a set of rear road wheels.

13. The assembly of claim 10, wherein each mechanism further comprises:
a locking collar continually secured to one of the halfshafts and displaceable into releasable engagement with one of the output shafts.

14. The assembly of claim 10, wherein each mechanism further comprises:
a locking collar continually secured to one of the halfshafts and displaceable into releasable engagement with one of the output shafts;
a sealed chamber containing a displaceable piston connected to the locking collar; and
a source of actuating pressure communicating with the chamber and producing differential pressure across the piston.

15. The assembly of claim 10, wherein each mechanism further comprises:
a locking collar continually secured to one of the halfshafts and displaceable into releasable engagement with one of the output shafts;
a sealed chamber containing a displaceable piston connected to the locking collar;
a source of actuating pressure communicating with the chamber and producing differential pressure across the piston; and
a spring urging the locking collar to engage the output shaft.

16. The assembly of claim 10, wherein the mechanism further comprises:
a locking collar continually secured to one of the halfshafts and displaceable into releasable engagement with one of the output shafts.
a sealed chamber containing a displaceable piston connected to the locking collar; and
a source of actuating pressure communicating with the chamber and producing differential pressure across the piston.

17. The assembly of claim 10, wherein the source of actuating pressure is one of a source of pneumatic pressure and a source of hydraulic pressure.

18. The assembly of claim 10, wherein the source of actuating pressure is one of a source of positive pressure and a source of negative pressure.
